(19) United States
(12) Patent Application Publication
(10) Pub. No.: US 2004/0161485 A1
(43) Pub. Date: Aug. 19, 2004

(54) Electric injection unit

(76) Inventor: Sentaro Kobayashi, Nagano-ken (JP)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/744,246

(22) Filed: Dec. 22, 2003

(30) Foreign Application Priority Data
Dec. 27, 2002 (JP) 2002-381405

(51) Int. Cl. B29C 45/48; B28B 1/00

(52) U.S. Cl. 425/3; 425/550; 425/587

(57) ABSTRACT

To simplify and downsize an apparatus by using a magnetic screw shaft and a magnetic nut member for a rotational-linear motion conversion mechanism used as an electric drive of an injection apparatus or the like.

In an electric injection unit using an electric motor as a driving source of an injection apparatus and a nozzle touch apparatus and having an electric drive for converting a rotational motion of the electric motor into a linear motion by a screw shaft and a nut member to perform injection or nozzle touch, the screw shaft and nut member are constituted by a magnetic screw shaft and a magnetic nut member.

### BACKGROUND OF THE INVENTION

1. Field of the Invention

The present invention relates to an electric injection unit for performing resin injection and nozzle-touch by converting a rotational motion by an electric motor into a linear motion.

2. Detailed Description of the Prior Art

Resin injection and nozzle-touch are hitherto performed by converting a rotational motion by an electric motor into a linear motion by a ball screw shaft and a ball nut (for example, refer to U.S. Pat. No. 6,247,622).

Further, a magnetic screw is used as moving means for a transportation device (for example, refer to Japanese Patent No. 2685723).

In the case of rotational-linear motion conversion means using a ball screw shaft and a ball nut member hitherto used, a ball circulation route is provided on the ball nut member, so that a relative movement between the screw shaft and the nut member in the shaft direction can be smoothly performed. Therefore, the circulation route is protruded in the shaft direction on the ball nut member, and this makes simplification and downsizing of the ball nut member difficult.

Moreover, when a screw is located at an forward position or backward position, a ball in a thread groove is also located at either of the fore and rear positions of the threaded groove correspondingly to the screw position. Therefore, when forward and backward movements of the screw are repeated for a long time, the ball receives a compression stress and thereby frequently causes a fatigue failure. Accordingly, tremendous care for the maintenance is required, for instance, lubricating to prevent heat generation due to friction is necessary.

The present invention is made to solve the conventional problem described above. The object of the invention is to provide an electric injection unit which is able to solve the said problem by electric driving means provided with a magnetic screw shaft and a magnetic nut member both of which can smoothly convert a rotational motion into a linear motion even if the screw shaft does not contact with the nut member, simplify and downsize an apparatus, and which can be easily maintained.

The present invention for achieving the above objects uses an electric injection unit comprising:

an electric drive apparatus using an electric motor as a drive source for an injection apparatus and a nozzle-touch apparatus to perform injection or nozzle-touch by converting a rotational motion produced by the electric motor into a linear motion by a screw shaft and a nut, wherein

the screw shaft consists of a magnetic screw shaft and the nut consists of a magnetic nut member.

Moreover, the present invention uses an electric injection unit comprising:

an injection apparatus having an apparatus body, a heating barrel having an injection screw arranged inside is attached to the fore end of the body, and a motor drive apparatus for injection attached to the rear end of the body; and

at least one nozzle-touch apparatus; wherein the motor drive apparatus for injection has;

a cylinder coupled to the rear end of the apparatus body,

a cylindrical screw thrust member provided in the cylinders so as to be movable forward and backward while preventing the member from rotating,

a magnetic nut member integrally provided in the screw thrust member,

a magnetic screw shaft which is inserted into the screw thrust member through the magnetic nut member from rear ends of the cylinders and whose fore end portion and rear end portion are supported by the screw thrust member and a bearing member at rear ends of the cylinder respectively, and

an electric injection servomotor provided to the rear end portion of the cylinder for rotating the magnetic screw shaft.

Furthermore, the present invention uses an electric injection unit comprising:

an injection apparatus having an apparatus body,

a heating barrel having an injection screw arranged inside being attached to the fore end of the body, and a motor drive apparatus for injection attached to the rear end of the body; and

at least one nozzle-touch apparatus, wherein the motor drive apparatus for injection has;

a plurality of cylinders coupled to the rear end of the body,

a plurality of cylindrical screw thrust members provided in the cylinders so as to be movable forward and backward while preventing the members from rotating,

a plurality of magnetic nut members integrally provided in the screw thrust members,

a plurality of magnetic screw shafts which are inserted into the screw thrust members through the magnetic nut members from the rear ends of the cylinders and whose front end portions and rear end portions are supported by the screw thrust members and bearing members at rear ends of the cylinders respectively, and

a plurality of electric servomotors provided to rear ends of the cylinders for rotating the screw shafts, and

fore ends of the screw thrust members are coupled to a slidable screw thrust plates in the body and the rotation shaft of an injection screw is rotatably coupled to the centers of the screw thrust plates.

Furthermore, the present invention uses an electric injection unit comprising:

an injection apparatus having an apparatus body, a heating barrel having an injection screw arranged inside being attached to the fore end of the apparatus body, and a motor drive apparatus for injection provided to the rear end of the body; and

at least one nozzle-touch apparatus, wherein the nozzle-touch apparatus has;

a cylinder attached to a setting plate provided on a side portion of the injection apparatus,

a cylindrical plunger provided so as to be movable forward and backward by passing through the setting plate from the inside of the cylinder,

a magnetic nut member integrally provided in the plunger,

a magnetic screw shaft which is inserted into the plunger through the magnetic nut member from the rear end of the cylinder and whose fore end portion and rear end portion are supported by the plunger and a bearing member at the rear end of the cylinder respectively,

an electric motor provided on the rear end of the cylinder for rotating the magnetic screw shaft for nozzle-touch, and

a nozzle-touch rod coupled to the plunger and a clamping plate of a clamping unit.

### BRIEF DESCRIPTION OF THE DRAWINGS

These and other advantages of the present invention will become clear from following description with reference to the accompanying drawing, wherein

FIG. 1 is a sectional side view of an injection apparatus of an electric injection unit of the present invention;

FIG. 2 is a top view of a nozzle-touch apparatus of the electric injection unit in FIG. 1 shown by crossing the apparatus;

FIG. 3 is a sectional side view of a driving section of the injection apparatus in FIG. 1;

FIG. 4 is a sectional top view of the driving section of the nozzle-touch apparatus in FIG. 2; and

FIG. 5 is a sectional top view of the rear portion of an electric injection apparatus of another embodiment.

### DETAILED DESCRIPTION OF THE PREFERRED EMBODIMENT

Hereinafter, the present invention will be described in detail with reference to the accompanying drawings, whereas the present invention is not limited thereto.

In the drawings, the numeral 1 represents an electric injection apparatus and the numeral 2 represents a pair of right and left electric nozzle-touch apparatuses both of which constitute an electric injection unit.

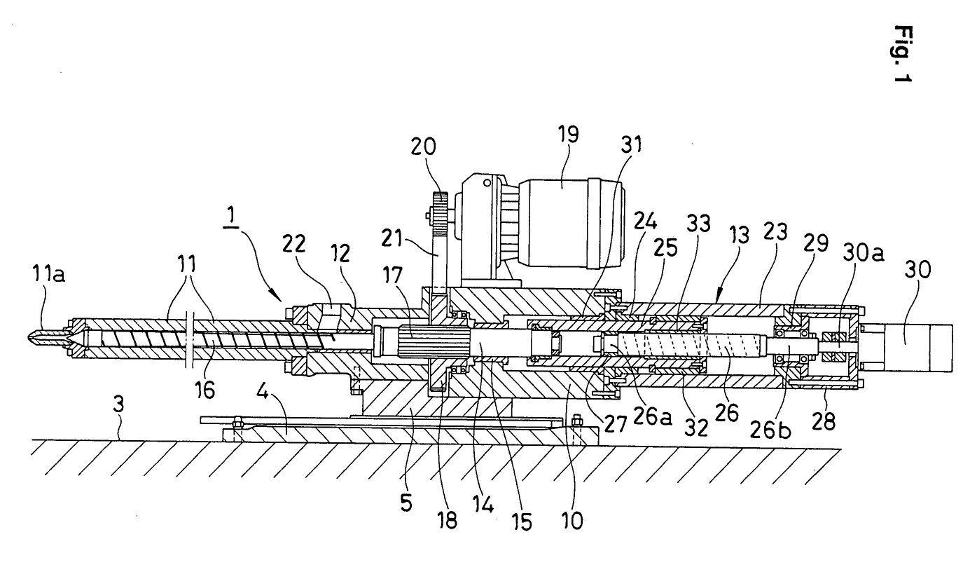

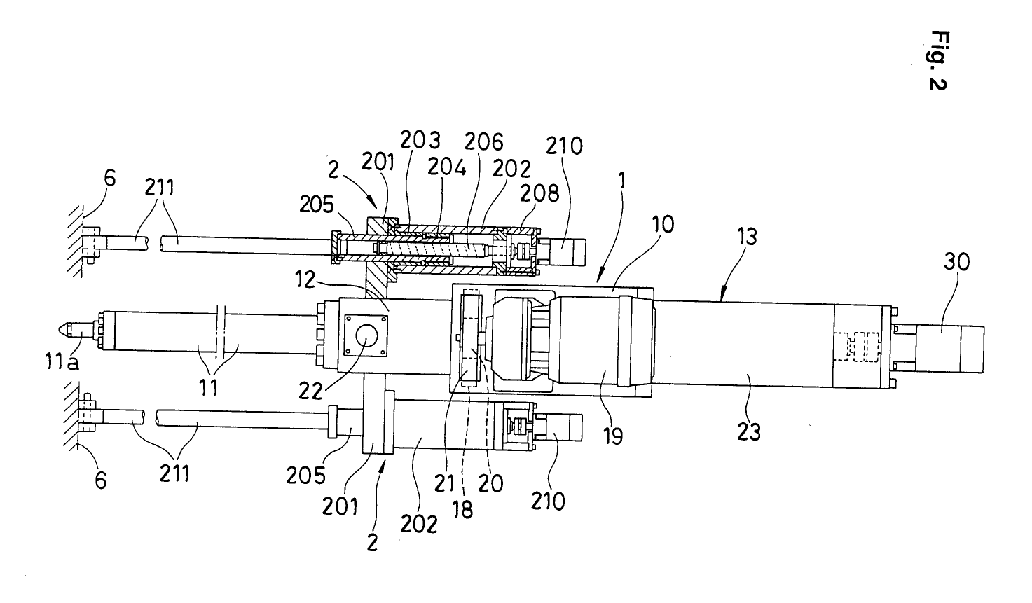

FIGS. 1 and 2 show embodiments of a horizontal electric injection apparatus 1 constituted by an oblong apparatus body 10 using a hollow block, a holding member 12 of a heating barrel 11 coupled to the front face of the body 10, and a single motor drive apparatus for injection 13 coupled to the back face of the body 10 and the body 10 is horizontally long fixed to a pedestal 5 mounted slidably on a seat board 4 on the upside of a bed 3 so that a nozzle 11a at the fore end of the heating barrel 11 can nozzle-touch the mold.

The rotating shaft 14 is provided up to the inside of the holding member 12 by being supported by a bearing 15 at the center of the inside of the body 10, and the rear end of an injection screw 16 arranged inside of the heating barrel 11 is coupled to the fore end of the rotating shaft 14. Moreover, a spline 17 is formed on the entire periphery of the rotating shaft 14, and a toothed pulley 18 for metering material resin is fitted to the spline 17. A timing belt 21 is wound on the toothed pulley 18 and a toothed pulley 20 of the driving shaft of an electric motor 19 for metering provided above the apparatus body 10. By the timing belt 21, the rotating shaft 14 is rotated together with the injection screw 16, so that the resin to be supplied by a supply port perforated on the top of the holding member 12 can be plasticized and metered.

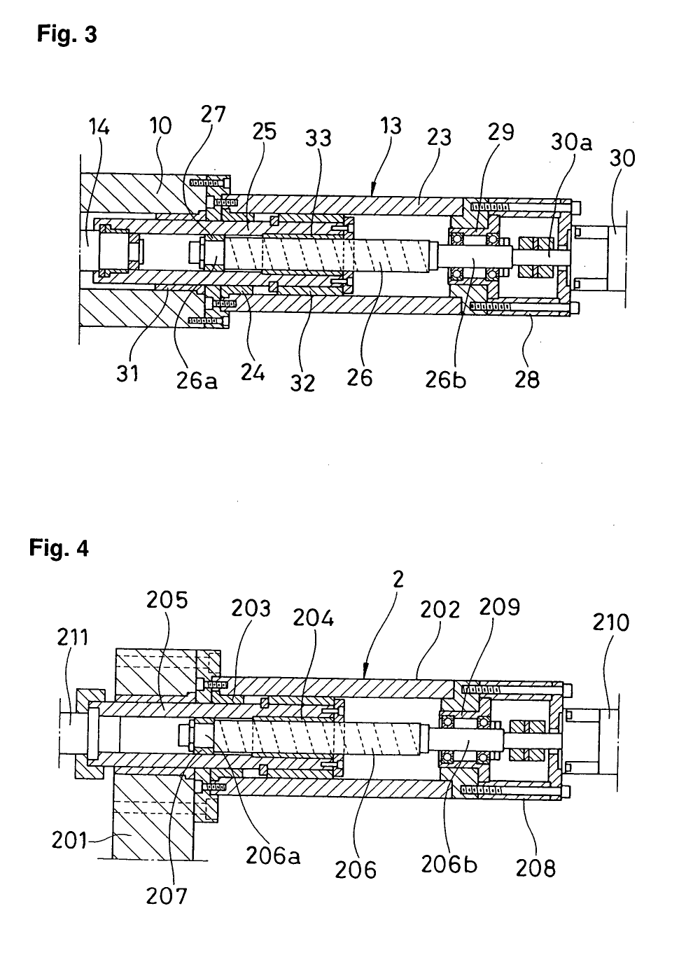

In the embodiments shown in FIGS. 1 and 3, the motor drive apparatus 13 for injection comprises the following elements: a cylinder 23 coupled to the rear end of the body 10; a cylindrical screw thrust member 25 provided movable in the region covering from the inside of the cylinder 23 to the inside of the apparatus body 10 while preventing the member from rotation by fitting to a spline bush 24 fitted into the coupled end of the cylinder 23; a magnetic screw shaft 26 inserted into the screw thrust member 25 from the rear end of the cylinder 23 and having a fore shaft end 26a supported by the screw thrust member 25 with a bearing 27; and an electric injection motor 30 comprised by an electric servomotor coupled to a housing 28 attached to the rear end of the cylinder to joint a driving shaft 30a on the rear end 26b of the magnetic screw 26 supported by a bearing member 29.

The screw thrust member 25 is slidably held to the inner wall of the body 10 and that of the cylinder 23 by bracing bushes 31 and 32 and the rear end of the rotating shaft 14 is rotatably coupled to the fore end of the member 25. Moreover, a magnetic nut member 33 is fitted into the rear end of the member 25, and the magnetic screw shaft 26 is inserted into the screw thrust member 25 through the magnetic nut member 33.

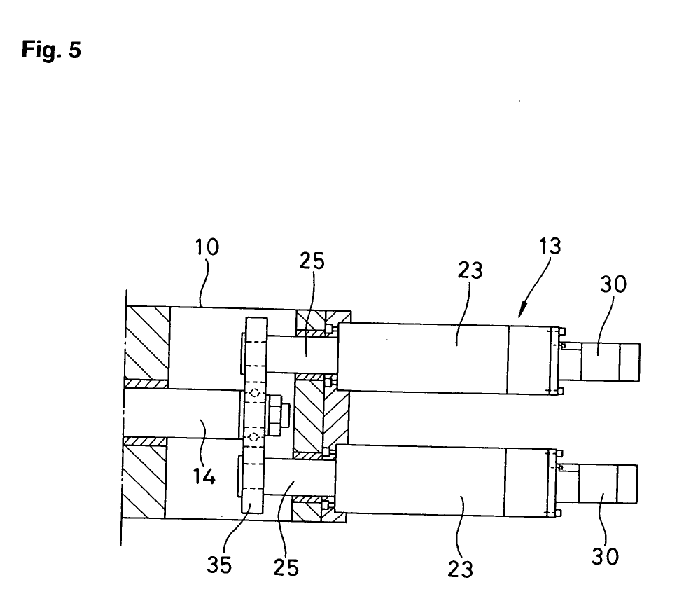

The embodiment shown in FIG. 5 is an electric injection apparatus having two or more of the motor drive apparatus for injection 13 at the back face of the body 10, which is constituted by connecting the both cylinders 23 and 23 to the body 10 in parallel and connecting fore ends of the screw thrust members 25 and 25 horizontally movably located in the body 10 to the back faces of the both sides of an oblong screw thrust plate 35 movably provided in the body 10 and rotatably connecting the rotating shaft 14 to whose fore end an injection screw is coupled to the center of the front face of the screw thrust plate 35 so as to move the injection screw forward by simultaneously operating the motor drive apparatuses for injection 13 and 13. Thereby, it is possible to injection-mold a molded product requiring an injection pressure.

In the case of the illustrated embodiment, the electric injection motor 30 is attached to the rear end of the cylinder 23 to directly connect with the magnetic screw shaft. However, it is also allowed to position the electric injection motor 30 parallel with the cylinder 23 so that rotation can be transferred to the magnetic screw shaft by transfer members such as a toothed pulley and a timing belt. Moreover, though the above embodiment is the horizontal type, it is also possible to set the embodiment as the vertical type under the above state without changing main constitutions. Therefore, it is possible to use the embodiment as a vertical electric injection unit.

The above electric nozzle-touch apparatus 2 shown in FIGS. 2 and 4 comprises the follwing elements; a pair of right and left setting plates 201 horizontally provided to the both sides of the the holding member 12 of the heating barrel 11; a cylinder 202 attached to the rear face of the setting plate 201 in parallel with the holding member 12; a cylindrical plunger 205 of horizontally movably attached to the fore end of the setting plate 201 from the inside of the cylinder through a bush 203 fitted into the coupled end of the cylinder 202 and integrally having a magnetic nut member 204 in the rear of the plunger 205; a magnetic screw shaft 206 which is inserted into the plunger 205 through the magnetic nut member 204 from the rear end of the cylinder 202 and whose fore shaft end 206a is supported to the plunger 205 by a bearing 207; an electric nozzle-touch motor 210 using a transmission-provided servomotor or gear motor or the like having a driving shaft 210a jointed to the rear shaft end 206b of the magnetic screw shaft 206 supported to a bearing member 209; and a nozzle-touch rod 211 provided in the range from the fore end of the plunger 205 up to the fixed plate 6 of a clamping device to fix the plunger 205 to the cylinder 202. The numerals 212 and 213 represent bracing bushes of the plunger 205.

The magnetic screw shafts 26 and 206 and the magnetic nut members 33 and 304 are constituted by alternately spirally arranged an N-pole magnetized band and an S-pole magnetized band to the outer periphery of a shaft material made of a permanent magnet material and the inner periphery of a cylindrical body made of a permanent magnet material at the same pitch with retaining strength of about 65N and the magnetic nut members 33 and 304 repulsively supported in accordance with the same poles faced each other by providing a predetermined clearance (for example 0.5 mm) for outer peripheries of the magnetic screw shafts 26 and 206 are rotated in the same direction by a magnetized band rotating together with the magnetic screw shafts 26 and 206. However, the cylinder 202 linearly moves because the screw thrust member 25 or the plunger 205 is prevented from rotating due to fitting or coupling and thereby the screw thrust member 25 is fixed in the case of the electric injection apparatus 1 and the plunger 205 is fixed in the case of the nozzle-touch apparatus 2.

Therefore, in the case of the electric injection apparatus 1, when rotating the electric motor 19 for metering at the foremost position of the screw after completing injection shown in FIG. 1, because the rotating shaft 14 is rotatably coupled to the screw thrust member 25, the screw thrust member 25 does not rotate but the rotating shaft 14 and the injection screw rotate and the material resin supplied from the supply port 22 is plasticized and metered.

However, when the magnetic screw shaft 26 is stopped, the screw thrust member 25 does not retreat due to the magnetic force between the shaft 26 and the magnetic nut member 33. Therefore, the magnetic screw shaft 26 is continuously or intermittently reversed while adding a toque (braking) against to a screw retreating force caused by a resin pressure to the magnetic screw shaft 26 by the electric injection motor 30 so as to retreat the screw thrust member 25 the same as the case of the back pressure control used for a normal ball screw shaft. Thereby, a back pressure for plasticizing and metering is generated and the screw thrust member 25 retreats up to a metering completion position together with the injection screw 16 while applying the back pressure control by the electric injection motor 30.

By normally rotating the magnetic screw shaft 26 at the home position by the electric injection motor 30 after the completion of metering, the screw thrust member 25 advances on the magnetic screw shaft, thrusts and advances the injection screw 16 at the retreat position after metering together with the rotating shaft 14, and injects and fills a metered resin in the fore end of the screw into a mold.

Moreover, in the case of the nozzle-touch apparatus 2, the plunger 205 is fixed by being coupled to the fixed plate 6 by the nozzle-touch rod 211. Therefore, by normally rotating the magnetic screw shaft 206 at the home position by the electric nozzle-touch motor 210 under the state shown in FIG. 2, the magnetic screw shaft advances together with the cylinder 202. Because the cylinder 202 is integrally attached to the setting plate 201 horizontally provided to the both sides of the electric injection apparatus 1, the electric injection apparatus 1 is attracted to the clamping device and thus the electric injection apparatus 1 slides on the seat board 4 and the nozzle 11a nozzle-touches the mold.

However, by reversing the magnetic screw shaft 206 by the electric motor 210 under a nozzle-touch state which is not illustrated, the magnetic screw shaft retreats together with the cylinder 202 and thereby, the electric injection apparatus 1 slides on the seat board 4 to be returned from the clamping device, the nozzle 11a separates from the mold, and nozzle-touch is canceled.

As described above, in the case of means for converting a rotational motion into a linear motion by a magnetic screw shaft and a magnetic nut member, a ball circulation route in the ball nut which is indispensable for a ball screw is unnecessary and any protruded portion disappears at a lateral portion of the magnetic nut member. Therefore, an apparatus is simplified. Moreover, because the magnetic nut member does not engage mechanically with a magnetic screw shaft differently from the case of a ball screw, but it floats around a screw shaft with a set clearance, a fatigue failure due to an compression stress does not occur and it can be used for a long time.

Furthermore, when receiving an impact force larger than the torque of a magnetic screw shaft in the axial direction, the magnetic screw shaft rotates correspondingly to the impact force and absorbs a impact of linear movement. Therefore, in the case of an electric injection apparatus, it is possible to prevent a damage due to the collision of the fore end of a screw which easily occurs in the molding for performing injection packing without leaving any cushion resin. Moreover, in the case of an electric nozzle-touch apparatus, because an impact for nozzle-touch is buffered and thereby, abrasion or damage of the fore end of a nozzle is prevented, and the apparatus lasts long.

While the presently preferred embodiment of the present invention has been shown and described, it will be understood that the present invention is not limited thereto, and that various changes and modification may be made by those skilled in the art without departing from the scope of the invention as set forth in the appended claims.

What is claimed is:

1. An electric injection unit comprising:
an electric drive apparatus using an electric motor as a drive source for as an injection apparatus and a nozzle-touch apparatus to perform injection or nozzle-touch by converting a rotational motion produced by the electric motor into a linear motion by a screw shaft and a nut, wherein
the screw shaft consists of a magnetic screw shaft and the nut consists of a magnetic nut member.

2. An electric injection unit comprising:
an injection apparatus having an apparatus body, a heating barrel having an injection screw arranged inside is attached to the fore end of the body, and a motor drive apparatus for injection attached to the rear end of the body; and
at least one nozzle-touch apparatus; wherein the motor drive apparatus for injection has;
a cylinder coupled to the rear end of the apparatus body,
a cylindrical screw thrust member provided in the cylinders so as to be movable forward and backward while preventing the member from rotating,
a magnetic nut member integrally provided in the screw thrust member,
a magnetic screw shaft which is inserted into the screw thrust member through the magnetic nut member from rear end of the cylinder and whose fore end portion and rear end portion are supported by the screw thrust member and a bearing member at rear end of the cylinder respectively, and
an electric injection servomotor provided to the rear end portion of the cylinder for rotating the magnetic screw shaft.

3. An electric injection unit comprising:
an injection apparatus having an apparatus body,
a heating barrel having an injection screw arranged inside being attached to the fore end of the body, and a motor drive apparatus for injection attached to the rear end of the body; and
at least one nozzle-touch apparatus, wherein the motor drive apparatus for injection has;
a plurality of cylinders coupled to the rear end of the body,
a plurality of cylindrical screw thrust members provided in the cylinders so as to be movable forward and backward while preventing the members from rotating,
a plurality of magnetic nut members integrally provided in the screw thrust members,
a plurality of magnetic screw shafts which are inserted into the screw thrust members through the magnetic nut members from the rear ends of the cylinders and whose front end portions and rear end portions are supported by the screw thrust members and bearing members at rear ends of the cylinders respectively, and
a plurality of electric servomotors provided to rear ends of the cylinders for rotating the screw shafts, and
fore ends of the screw thrust members are coupled to a slidable screw thrust plates in the body and the rotation shaft of an injection screw is rotatably coupled to the centers of the screw thrust plates.

4. An electric injection unit comprising:
an injection apparatus having an apparatus body, a heating barrel having an injection screw arranged inside being attached to the fore end of the apparatus body, and a motor drive apparatus for injection provided to the rear end of the body; and
at least one nozzle-touch apparatus, wherein the nozzle-touch apparatus has;
a cylinder attached to a setting plate provided on a side portion of the injection apparatus,
a cylindrical plunger provided so as to be movable forward and backward by passing through the setting plate from the inside of the cylinder,
a magnetic nut member integrally provided in the plunger,
a magnetic screw shaft which is inserted into the plunger through the magnetic nut member from the rear end of the cylinder and whose fore end portion and rear end portion are supported by the plunger and a bearing member at the rear end of the cylinder respectively,
an electric motor provided on the rear end of the cylinder for rotating the magnetic screw shaft for nozzle-touch, and
a nozzle-touch rod coupled to the plunger and a clamping plate of a clamping unit.
